(19) United States
(12) Patent Application Publication
(10) Pub. No.: US 2006/0049559 A1
(43) Pub. Date: Mar. 9, 2006

(54) Cushioning member and method of manufacturing the same

(75) Inventors: Yasuyuki Ohara, Nagoya-shi (JP); Hajime Takami, Anjo-shi (JP); Takashi Kawashita, Nishio-shi (JP); Grant Wylie, Hemlock, NY (US)

Correspondence Address: Kenneth J LuKacher;South Winton Court, Suite 204, 3136 Winton Road South, Rochester, NY, 14623, US

(73) Assignees: TSUCHIYA TSCO CO., LTD., Chiryu-shi (JP); Ultrafab, Inc., Farmington, NY (US)

(21) Appl. No.: 10/532,749

(22) PCT Filed: Oct. 30, 2003
(86) PCT No.: PCT/US03/34393

§ 371 Date: Apr. 26, 2005

(30) Foreign Application Priority Data
Oct. 31, 2002 (JP) 2002-318046

(51) Int. Cl. F16F 1/36

(52) U.S. Cl. 267/148

(57) ABSTRACT

A cushioning member is located between each support frame and the corresponding side of the shutter. The cushioning member includes a pair of belt-shaped base members and pile yarns bridging between the base members. Some of the pile yarns are cut at intermediate portion between the base members, which forms opposing first and second cut pile yarns with a cut in between. One of the base members is attached to each support frame, and the other base member contacts the shutter. The cut permits the cushioning member to flexibly respond to movements of the shutter and satisfactorily exerts a cushioning function to suppress swaying of the shutter.

### TECHNICAL FIELD

The present invention relates to a cushioning member and a method for manufacturing the cushioning member. For example, the present invention relates to a cushioning member for a shutter apparatus including a pair of opposed support frames and a shutter for moving between the support frames, the cushioning member being interposed between the support frames and opposite sides of the shutter.

### BACKGROUND ART

Conventionally, as disclosed in Japanese Utility Model Registration No. 2592349, a silencing band structure has been proposed as a cushioning member for the shutter apparatus of the above-mentioned kind. More specifically, a silencing band body according to this silencing band structure includes a band-shaped sliding element and a band-shaped base, which are both formed of a hard material, such as hard vinyl chloride. The sliding element and the base are bridged with mohair such that the components of the sliding element, the base, and the mohair are integrated to substantially form layers of a unitary member.

The silencing band bodies are mounted on guide rails via the bases, and have the sliding elements slidably brought into abutment with front and rear surfaces of a shutter curtain mounted on the guide rails. When the shutter curtain is opened and closed, the silencing band structure causes the sliding elements to slide smoothly on the front and rear surfaces of the shutter curtain, thereby helping the shutter curtain be opened and closed smoothly.

In the conventional shutter apparatus, the shutter curtain (as a shutter) attempts to move in all directions with respect to the guide rails (support frames), including both front-rear directions and lateral directions, thereby causing swaying motions. This occurs in various situations, including not only when urged by the wind but also when the shutter is opened and closed.

In response to such motions, when the shutter curtain moves in the front-rear directions, the silencing band body has the mohair as pile yarns bent between the sliding element and the base via the sliding element. This suppresses generation of noise, such as rattling noise caused by wind. More specifically, the silencing band body has a cushioning function by the operation of the mohair that suppresses motions of the shutter curtain in the front-rear directions caused, for example, by the urging of the wind. However, when the shutter curtain is moved in lateral directions, the sliding element following the motion is pulled by mohair located on opposite lateral sides with respect to the direction of motion thereof, which makes the sliding element difficult to move, and which prevents the cushioning function from being fully performed.

Then again, when the conventional silencing band body is actually manufactured, it is possible to employ a method of forming a mohair member by setting mohair on the sliding element or the base, arranging ends of mohair in order, raising mohair, and other necessary operations, and then bonding the base or the sliding element to the mohair of the mohair member. It is possible to employ another method of forming a pair of mohair members, and bonding mohair ends of the mohair members to each other. Whichever method may be employed, it is required to once form the mohair member, and hence the manufacturing process is complicated. Furthermore, since the mohair is flexible, it is difficult to bond the mohair only by mohair ends, or aligning them, which makes it very difficult to manufacture the silencing band body.

### SUMMARY OF THE INVENTION

It is an object of the present invention to provide a cushioning member that performs a satisfactory cushioning function.

It is another object of the present invention to provide a method of manufacturing a cushioning member, which is capable of easily and reliably manufacturing the cushioning member comprised of a pair of base members and pile yarns bridging between the base members.

To achieve the above objects, the present invention provides a cushioning member that includes a pair of base members disposed in a manner opposed to each other and having a band shape, and a plurality of pile yarns bridging between the base members. Some of the pile yarns are cut at an intermediate portion between the base members to form first cut pile yarns and second cut pile yarns. The first and second cut pile yarns face each other with a cut in between.

The present invention also provides a method of manufacturing a cushioning member. The method includes a wrapping step of wrapping pile yarns around surfaces of an endless band while rotating the endless band; a base member supply step of supplying to the pile yarns wound around the endless band a pair of base members which are band-shaped from opposite lateral sides of the endless band; a bonding step of bringing the supplied base members into contact with the pile yarns, and bonding the base members to the pile yarns by using ultrasonic waves; a cutting step of cutting the pile yarns located on one of inner and outer circumferences of the endless band at intermediate portion between the base members, thereby forming a cut in the pile yarns; and a separating step of separating the pile yarns together with the base members from the endless band via the cut.

### BRIEF DESCRIPTION OF THE DRAWINGS

FIG. 1 is a perspective view of a cushioning member according to a first embodiment of the present invention;

FIG. 2(a) is a front view of the cushioning member;

FIG. 2(b) is a rear view of the cushioning member;

FIG. 2(c) is a plan view of the cushioning member;

FIG. 2(d) is a right side view of the cushioning member;

FIG. 2(e) is a left side view of the cushioning member;

FIG. 3 is a front view, partly broken, of a shutter apparatus;

FIG. 4 is a horizontal sectional view of a support frame with cushioning members mounted thereon;

FIG. 5 is a vertical sectional view of the support frame with the cushioning members mounted thereon;

FIGS. 6(a) and 6(b) each are a plan view of pile yarns displaced laterally at a cut;

FIG. 7(a) is a conceptual diagram of an apparatus for manufacturing the cushioning member of FIG. 1, in plan view;

FIG. 7(b) is a conceptual diagram of the apparatus for manufacturing the cushioning member of FIG. 1, in side view;

FIG. 8 is a cross-sectional view illustrating an example in which the cushioning member of FIG. 1 is used as a support member for a screen;

FIG. 9 is a front view illustrating a cushioning member according to a second embodiment of the present invention;

FIG. 10 is a cross-sectional view illustrating an example in which the cushioning member of FIG. 9 is used as a support member for a pane of a sliding window;

FIG. 11(a) is a conceptual diagram of an apparatus for manufacturing the cushioning member of FIG. 9, in plan view;

FIG. 11(b) is a conceptual diagram of the apparatus for manufacturing the cushioning member of FIG. 9, in side view;

FIG. 11(c) is a cross-sectional view for explaining the manufacturing procedure of the cushioning member of FIG. 9;

FIG. 12 is a front view illustrating a cushioning member according to a third embodiment of the present invention;

FIG. 13 is a cross-sectional view illustrating an example in which the cushioning members of FIG. 12 are used in a shutter apparatus;

FIG. 14 is a cross-sectional view illustrating an example in which the cushioning member of FIG. 12 is used in a ventilation system;

FIG. 15(a) is a conceptual diagram of an apparatus for manufacturing the cushioning member of FIG. 12, in plan view;

FIG. 15(b) is a conceptual diagram of the apparatus for manufacturing the cushioning member of FIG. 12, in side view;

FIG. 15(c) is a cross-sectional view for explaining the manufacturing procedure of the cushioning member of FIG. 12;

FIGS. 16(a) to 16(c) are front views each illustrating a joint cushioning member having a pair of the cushioning members of FIG. 1; and

FIG. 17 is a cross-sectional view illustrating an example in which the cushioning member of FIG. 16(a) is used in a shutter apparatus.

### BEST MODE FOR CARRYING OUT THE INVENTION

Hereinafter, a first embodiment of the present invention will be described with reference to the drawings.

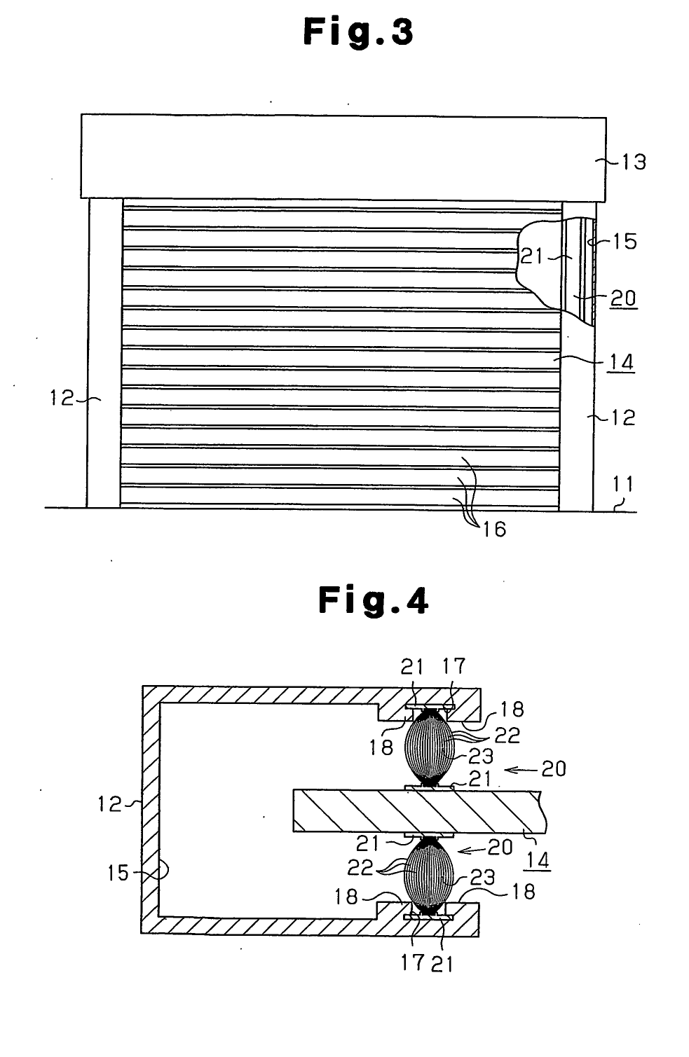

First, a description will be given of the construction of a shutter apparatus that uses cushioning members for a shutter apparatus. As shown in FIGS. 3 to 5, the shutter apparatus is comprised of a pair of support frames 12 set upright on a floor 11 in a manner opposed to each other, a housing 13 bridging between upper ends of the support frames 12, and a shutter 14 disposed inside the floor 11, the pair of support frames 12, and the housing 13. The support frames 12 function as guiding members. The shutter 14, which functions as a moving member, is formed by joining a plurality of vane plates 16 such that the vane plates 16 pivot relative to each other. The shutter 14 can be wound round in a spiral manner by pivotally moving each vane plate 16. Further, inside the housing 13, a hollow cylindrical drum, not shown, is rotatably supported, and an upper end of the shutter 14 is connected to an outer periphery of the drum. Also, as the drum rotates in one direction, the shutter 14 is wound around the outer periphery of the drum, and is received in the housing 13, which places the shutter apparatus in an open state. On the other hand, as the drum rotates in the other direction, the shutter 14 is unwound from the outer periphery of the drum, and is pulled out of the housing 13, which places the shutter apparatus in a closed state.

The support frames 12 are each formed as a hollow square pole of metal, and each support frame 12 has a guide groove 15 formed between inner end faces thereof such that the guide groove 15 opens toward the inside of the shutter apparatus. The shutter 14 has opposite ends. One of the opposite ends is inserted in the guide groove 15 of each support frames 12. When the opening or closing operation is carried out to place the shutter apparatus in the open state or the closed state, each support frame 12 functions to support the shutter 14 while guiding the shutter 14 the guide grooves 15 such that the shutter 14 can vertically reciprocate. Further, each guide groove 15 has opposite inner surfaces each of which is formed with a receiving linear recess 17. The receiving linear recesses 17 extend along the longitudinal direction of the frame 12 and open toward the front surface and the rear surface of the shutter 14. These receiving linear recesses 17 each have open ends thereof formed with a pair of protrusions 18, whereby the opening of the receiving linear recess 17 is limited to a predetermined width. Gaps are formed between one of the inner surfaces of each guide groove 15 and the front and between the other inner surface of the guide groove 15 and the rear surface of the shutter 14, respectively. Cushioning members 20 for a shutter apparatus are respectively received in the receiving linear recesses 17 such that the cushioning members 20 block the gaps.

Next, the construction of the cushioning member 20 will be described.

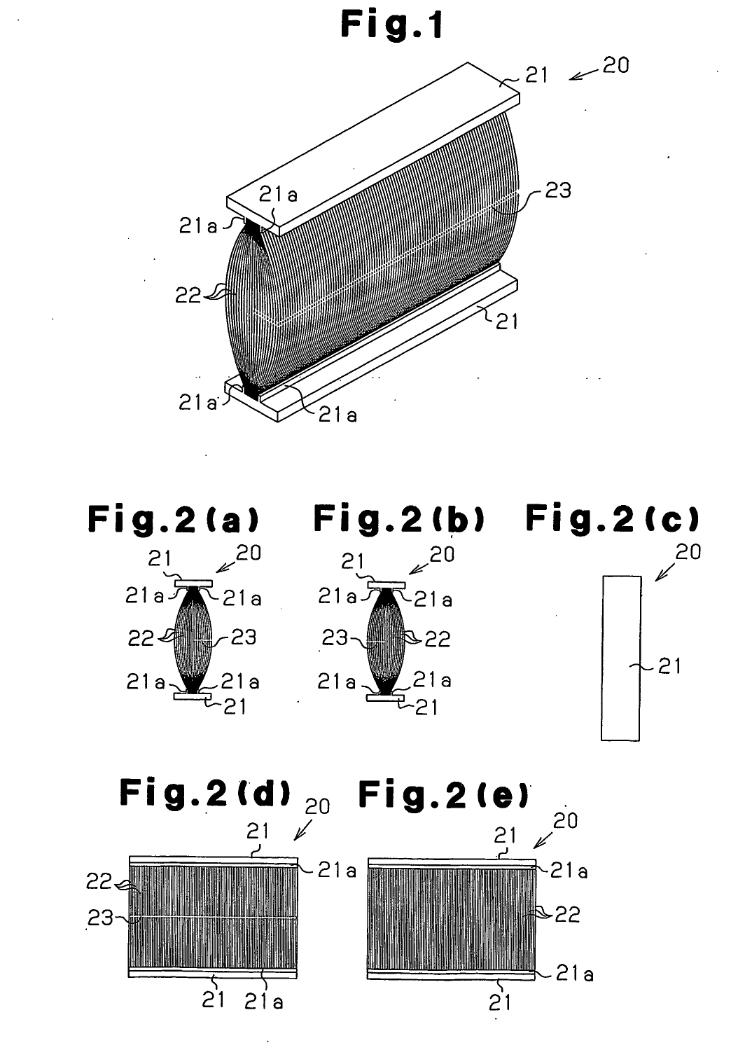

As shown in FIG. 1 to 2(e), the cushioning member 20 is comprised of a pair of base members 21 having a band shape and disposed in a manner opposed to each other, and a plurality of pile yarns 22 set on the base members 21 in a manner bridging the pair of base members.

The base members 21 are formed of a film of a synthetic resin having an excellent wear resistance and a low coefficient of kinetic friction. Examples of such a synthetic resin include olefinic resins, such as ultra-high polymer polyethylene and polypropylene; amide resins, such as aliphatic polyamides and aromatic polyamides; acrylic resins, such as polyacryl; ester resins, such as polyethylene terephthalate; fluorocarbon resins, and so forth. Further, at an intermediate portion in the width of each base member 21, there is formed a pair of guide linear protrusions 21a that extend along the length of the base member with a predetermined gap between the pair of protrusions. The pair of guide linear protrusions 21a are in parallel with each other to position the pile yarns 22.

The pile yarns 22 are bent into a U shape, and the bent portion of the pile yarns 22 is inserted between the two guide linear protrusions 21a. Methods of joining the pile yarns 22 to the base member 21 include using an adhesive or ultrasonic waves, welding by application of heat, and so forth, from which a suitable one is selected as desired. Among them, ultrasonic bonding is preferable since the base member 21 and the pile yarns 22 can be firmly joined to each other, and changes in the shape of the pile yarns 22 can be suppressed except at the joined portion thereof.

The pile yarns 22 are formed of yarns of fibers having a high durability and excellent in a restoring property and a non-water-absorbing property, such as filament yarns, spun yarns, or like yarns. Examples of such fibers include synthetic fibers made of synthetic resins mentioned concerning the base members 21, semisynthetic fibers made of rayon or the like, natural fibers made of cotton or the like, etc. Among these, particularly synthetic resins made of olefinic resins, such as polypropylene; amide resins made, for example, of aliphatic polyamides and aromatic polyamides have an excellent restoring property of restoring from the compressed state, which make them more preferable as fibers for the pile yarns 22. Further, when the pile yarns 22 are joined to the base member 21 by ultrasonic bonding, it is further preferable to use a synthetic resin that is of the same family that is used for the base member 21.

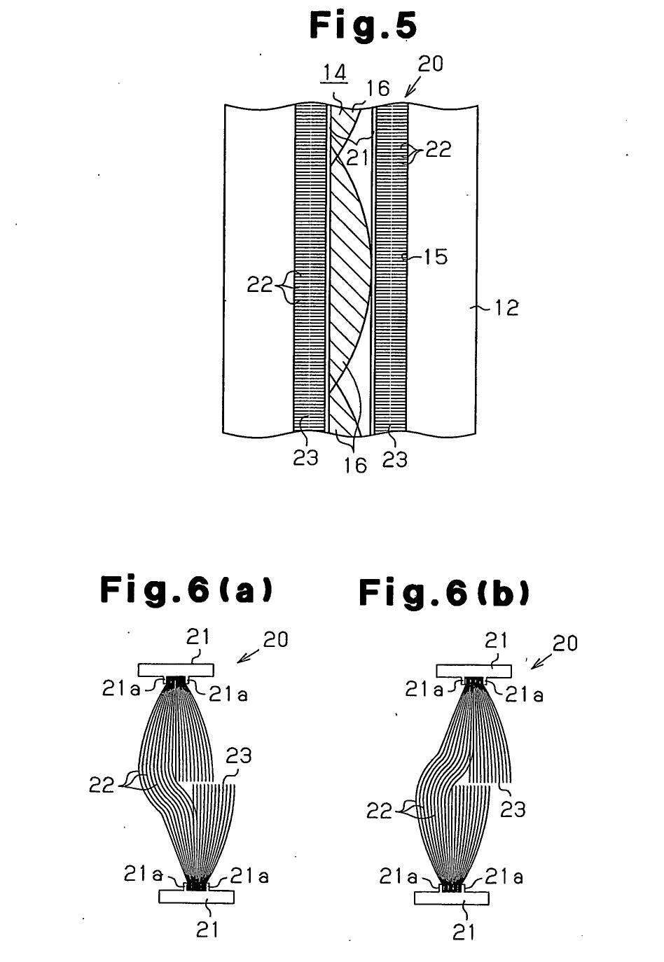

As shown in FIGS. 4 and 5, the cushioning member 20 is fixed to the guide groove 15 of the support frame 12 by having a first base member 21 inserted into the receiving linear recess 17. Further, the second base member 21 of the cushioning member 20 is supported on the pile yarns 22 protruding from the opening of the receiving linear recess 17, and at the same time urged on the front surface or back surface of the shutter 14 by the same pile yarns 22, for being brought into contact therewith. The shutter 14 is supported by a pair of cushioning members 20 in a manner sandwiched thereby from the front and rear sides.

When the shutter is opened and closed, the shutter 14 is reciprocated vertically with the front and rear surfaces thereof being slid on the second base members 21 of the cushioning members 20. At this time, since the second base members 21 are formed of the synthetic resin having a low coefficient of kinetic friction, the shutter 14 slides on the cushioning members 20, whereby the cushioning members 20 perform the function of reducing the sliding resistance offered when the shutter is opened and closed.

When the shutter is opened and closed while the shutter is urged by the wind, or on like occasions, the shutter 14 is urged toward the second base members 21 due to swaying or rattling motion thereof. At this time, the shutter 14 is received by the pile yarns 22 via the second base members 21, and is urged back, whereby the cushioning members 20 suppress swaying and rattling motions of the shutter 14.

To enable the cushioning members 20 to satisfactorily perform the resistance-reducing function and the cushioning function, the pile yarns 22 have a single yarn fineness of 5 to 110 decitex, more preferably 10 to 70 decitex, further preferably 10 to 35 decitex. Conventionally, a strand (multi-filament strand) formed by twisting together a plurality of filaments, or fibers, is used for a pile yarn 22. The term “single yarn fineness” refers to a degree of fineness of one filament in a single pile yarn 22. As the single yarn fineness is decreased, the rigidity of the pile yarns 22 is lowered, which can undesirably inhibit the cushioning members 20 from fully performing a desired cushioning function, and can cause inconveniences, such as yielding of the pile yarns 22. As the single yarn fineness is increased, the flexibility of the pile yarns 22 becomes lowered, which causes the second base member 21 to be pressed against the shutter 14 with a strong force. This makes it impossible for the cushioning members 20 to fully perform the resistance-reducing function, causing inconveniences when the shutter 14 is opened and closed.

Further, the fineness of the pile yarn 22 itself is preferably 100 to 2200 decitex, more preferably 500 to 2200 decitex, most preferably 600 to 1650 decitex. In some cases a strand (mono-filament strand) formed by a single filament, instead of a multi-filament strand, is used for the pile yarn 22. For excellent performance of the resistance-reducing function and the cushioning function, it is preferred that the fineness of the pile yarn 22 itself is set as described above. Further, as the fineness of the pile yarn 22 is decreased, the rigidity of the pile yarns 22 is lowered, which makes it impossible for the cushioning members 20 to fully performing the desired cushioning function. As the fineness of the pile yarn 22 is increased, the flexibility of the pile yarns 22 is lowered, which makes it possible to fully perform the resistance-reducing function.

The number of pile yarns 22 set on the base member 21 is preferably 1000 to 10000 per inch along the length of the base member 21, more preferably 1000 to 8000, most preferably, 1500 to 6500. As the number of pile yarns 22 per inch along the length of the base member 21 decrease, the density of the pile yarns 22 on the base member 21 becomes lower, which makes it easier to form space between the pile yarns 22. When the density of the pile yarns 22 is lowered, the pile yarns 22 cannot support each other, which lowers the rigidity of the whole pile yarns 22. This makes it impossible to sufficiently receive the shutter 14, and fully perform the cushioning function. As the number of pile yarns 22 per inch increases, the density of the pile yarns 22 on the base member 21 becomes higher, which makes the pile yarns 22 liable to be excessively dense. When the density of the pile yarns 22 thus becomes excessively dense, the flexibility of the whole pile yarns 22 becomes low, so that the second base member 21 is caused to be pressed against the shutter 14 with a strong force, which increases the sliding resistance, thereby making it impossible for the cushioning members 20 to fully perform the resistance-reducing function.

As shown in FIG. 1 to 2(e), part of pile yarns 22, specifically, the pile yarns 22 that are set toward one side from the center in the direction of width of the base member 21 are cut at intermediate portion between the base members 21. The cut pile yarns 22 include first cut pile yarns 22 extending from the first base member 21, and second cut pile yarns 22 extending from the second base member 21. The distal ends (cut ends) of the first cut pile yarns 22 and the distal ends (cut ends) of the second cut pile yarns 22 face each other with the cut 23 in between. The cut 23 is formed such that it extends along the length of the base member 21 over the whole length of the cushioning member 20.

The cut pile yarns 22 open to have ends thereof spread apart. The distal portion of the cut pile yarns 22 bulge in a lateral direction relative to the length of the base members 21. Therefore, the cut pile yarns 22 are denser at the proximal portion than at the distal portion. The pile yarns 22 other than the cut pile yarns 22, that is, non-cut pile yarns 22 connecting the base members 21 to each other are flexed between the base members 21 to bulge in a lateral direction relative to the length of the base members 21. Therefore, the non-cut pile yarns 22 are denser at the proximal portion than at the intermediate portion. The pile yarns 22 as a whole are expanded at a central portion thereof between the two base members 21 in the opposite lateral directions with respect to the longitudinal direction of the base members 21, whereby the cross-section perpendicular to the length of the base members 21 is approximately rhombus-shaped. The flexed portion of the non-cut pile yarns 22 are more easily bent, compared with straight pile yarns.

If the pile yarns 22 are crushed and compressed when the pile yarns 22 receive external force by way of the second base member 21 as the shutter 14 moves, the pile yarns 22 generates resilient force to restore the original shape. The cushioning function of the cushioning member 20 is exhibited by the resilient force. However, as the resilient force of the pile yarns 22 is increased, the second base member 21 is excessively pressed against the shutter 14 with a larger force, which increases the sliding resistance of the shutter 14 to the cushioning members 20, to make it impossible for the cushioning members 20 to fully perform the resistance-reducing function. Therefore, in this embodiment, the cushioning members 20 are formed with the cut 23, whereby the cushioning function and the resistance-reducing function are suitably performed depending on the situation. More specifically, the cushioning members 20 perform the cushioning function and the resistance-reducing function in a well-balanced manner when receiving a weak external force. When receiving a strong external force, the cushioning members 20 perform the cushioning function preferentially over the resistance-reducing function. When the shutter 14 sways during opening and closing of the shutter 14, the cushioning members 20 receive a relatively weak external force. When the shutter 14 is urged by wind, the cushioning members 20 receive a relatively great external force.

More specifically, when a weak external force applied to the cushioning members 20 as the shutter 14 moves frontward and rearward, the non-cut pile yarns 22 bow and the entire non-cut pile yarns 22 are uniformly bent to generate the resilient force. On the other hand, in the cut pile yarns 22, the ends of the first cut pile yarns 22 or the second pile yarns 22, with the cut 23 in between, enter between the ends of the other cut pile yarns 22. Therefore, the cut pile yarns 22 do not generate the resilient force. This softens the resilient force applied from the whole pile yarns 22 to the shutter 14. Therefore, when the external force is weak, the cushioning members 20 generate only a resilient force corresponding to the external force, but appropriately perform the cushioning function to a necessary and sufficient extent to thereby suppress swaying of the shutter 14 and generation of unusual noise, such as rattling, when the shutter 14 is opened and closed. Further, since only the resilient force corresponding to the external force is generated, the cushioning function and the resistance-reducing function are performed in a well-balanced manner, whereby the operations of opening and closing the shutter 14 are properly performed.

When the external force applied to the cushioning members 20 is relatively strong, the ends of the first cut pile yarns 22 or the second pile yarns 22, with the cut 23 in between, deeply enter between the ends of the other cut pile yarns 22. At this time, since the cut pile yarns 22 are denser toward the proximal ends, the first and second cut pile yarns 22 are easily hooked with each other, which increases the resistance generated when the cut pile yarns 22 engage with one another. Alternatively, the ends of the cut pile yarns 22 engage with the base members 21. This causes the cut pile yarns 22 to be bowed similarly to the non-cut pile yarns 22, and the whole thereof is uniformly bent to generate the resilient force. As the external force applied to the cushioning members 20 is increased, the resistance generated when the facing cut first or second pile yarns 22 enter the other cut pile yarns 22 is increased, or the number of the cut pile yarns 22 that are hooked with one another is increased. Accordingly, the resilient force generated by the cut pile yarns 22 is increased. Therefore, when the applied external force is relatively strong, the cushioning members 20 perform the cushioning function preferentially over the resistance-reducing function, thereby generating strong resilient forces capable of sufficiently receiving the strong external force. As a result, the cushioning members 20 suppress large motion of the shutter 14, as well as generation of large unusual noise, such as rattling noise caused by wind.

The cushioning members 20, each having a length of 10 cm, were actually made using pile yarns 22 made of polypropylene and having a fineness of 1350 decitex/52 filaments, such that 1800 yarns were set per inch along the length of the base members 21, and a distance between the base members 21 was equal to 7 mm. Then, the cushioning member 20 was compressed in the direction of extension of the pile yarns 22 (in a direction decreasing the distance between the base members 21), and the resilient force generated by the cushioning members 20 was measured. The result of the measurement showed that until the amount of compression becomes equal to 2 mm, the resilient force is linearly increased in proportion to the compressive force, and that when the amount of compression exceeds 2 mm, the resilient force is increased in a curve more than corresponding to the compressive force.

In addition, when the shutter 14 moves laterally, as shown in FIGS. 6(a) and 6(b), the first and second cut pile yarns 22, which face each other with the cut 23 in between, are laterally displaced with respect to each other (in a lateral direction as viewed in FIGS. 6(a) and 6(b)). This enables the second base member 21 to flexibly follow the motion of the shutter 14, and the cushioning member 20 always maintains contact between the second base member 21 and the shutter 14. Therefore, the cushioning members 20 flexibly follow all motions of the shutter 14, and fully perform the above-described cushioning function and the resistance-reducing function.

Next, the construction of an apparatus for manufacturing the cushioning member 20 will be described.

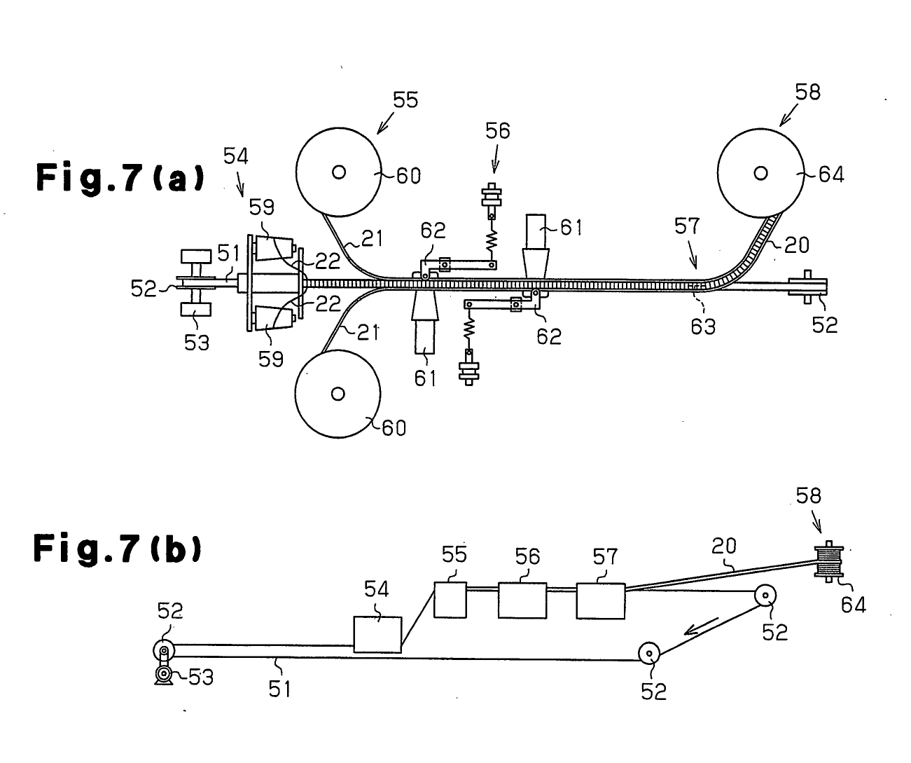

As shown in FIGS. 7(a) and 7(b), the manufacturing apparatus includes an endless band 51 formed by connecting opposite ends of a band-shaped member. The endless band 51 extends around a plurality of rollers 52. Assuming that a left side end as viewed in the figures is a starting end and a right side end in the same is a terminating end, the endless band 51 is rotated within the apparatus as the rollers 52 at the starting end side are driven by a rotation drive apparatus 53. Between the rollers 52 at the starting end side and rollers 52 at the terminating end side, there are arranged a pile yarn supply section 54, a base member supply section 55, a bonding section 56, a cutting section 57, and a collecting section 58, in the order from the starting end side to the terminating end side.

The pile yarn supply section 54 includes a pair of bobbins 59 opposed to each other with the endless band 51 therebetween. The bobbins 59 are configured such that they rotate about an axis along the extending direction of the endless band 51 while supplying the pile yarns 22 onto the surface of the endless band 51. The base member supply section 55 includes a pair of supply drums 60 opposed to each other, with the endless band 51 therebetween. Each supply drum 60 has the base member 21 received thereon in a state wound therearound, and the base members 21 unwound from the supply drum 60 are supplied to opposite lateral sides of the endless band 51 to hold the endless band 51, such that the supplied base members 21 are moved in parallel with the endless band 51.

The bonding section 56 includes a pair of horns 61 for transmitting ultrasonic vibrations to the base members 21 and a pair of urging members 62 for urging the base members 21 against the endless band 51. Each horn 61 forms a pair with one of the urging members 62. Each pair of one of the horns 61 and the associated urging member 62 sandwiches the endless band 51, and the two pairs are arranged in a staggered configuration with respect to the direction of rotation of the endless band 51. That is, the first horn 61 faces the first urging member 62, and the second horn 61 faces the second urging member 62. The cutting section 57 includes a cutting blade 63 that faces the inner or outer circumference of the endless band 51. In FIGS. 7(a) and 7(b), the cutting blade 63 faces the inner circumference of the endless band 51, and the cutting blade 63 is disposed in the center in the direction of width of the endless band 51. The collecting section 58 has a collecting drum 64 disposed toward one side of the endless band 51, and the manufactured cushioning members 20 are taken up on the collecting drum 64, for being collected.

Next, a description will be given of a method of manufacturing the cushioning member 20 using the above manufacturing apparatus.

The cushioning member 20 is made through a wrapping step, a base member supply step, a bonding step, a cutting step, and a separating step.

The wrapping step is performed for wrapping pile yarns 22 around the surfaces of the endless band 51, and is executed by the pile yarn supply section 54 of the manufacturing apparatus. In the pile yarn supply section 54, the pair of bobbins 59 supply pile yarns 22 onto the endless band 51 while rotating about the endless band 51. Then, the pile yarns 22 supplied onto the endless band 51 is wound around the surfaces of the endless band 51 in a spiral manner, and is moved toward the terminating end together with the endless band 51.

The base material supply step is performed for supplying the base members 21 from lateral sides of the endless band 51 to the pile yarns wound around the endless band 51, and is executed by the base member supply section 55 of the manufacturing apparatus. In the base member supply section 55, the base members 21 unwound from the respective supply drums 60 are supplied such that the base members 21 are positioned at the opposite lateral sides of the endless band 51. At this time, positioning is carried out such that the pile yarns 22 wound around the endless band 51 are positioned between a pair of guide linear protrusions 21a provided on each base member 21.

The bonding step is performed for bringing the supplied base members 21 into contact with the pile yarns 22 and causing the base members 21 and the pile yarns 22 to be bonded to each other using ultrasonic waves, and is executed by the bonding section 56 of the manufacturing apparatus. In the bonding section 56, while each urging member 62 urges one of the base members 21 from one lateral side of the endless band 51 to bring the same into contact with the pile yarns 22, the horns 61 are brought into contact with the other base member 21 from the other lateral side of the endless band 51. Then, ultrasonic vibrations are transmitted via the horns 61 to the base members 21, and due to the vibrations of the ultrasonic waves, the base members 21 and the pile yarns 22 are bonded at the site where they are in contact with each other.

The cutting step is performed for cutting the pile yarns 22 at an intermediate portion of the base members 21 on one of the inner and outer circumferences of the endless band 51, to form the cut 23, and is executed by the cutting section 57 of the manufacturing apparatus. In the cutting section 57, a center of the lower half of the pile yarns 22 wound around the endless band 51 is cut through by the cutting blade 63 facing the inner circumference of the endless band 51. As a result, the cushioning member 20 having the cut 23 is made in a manner covering the endless band 51.

The separating step is performed for separating the pile yarns 22, together with a pair of base members 21, via the cut 23 from the other side of the endless band 51, and is executed by the collecting section 58 of the manufacturing apparatus. In the collecting section 58, the cushioning member 20 on the endless band 51 is pulled upward, either by rotation of the drum 64 or manual operation of workers. This causes the first and second cut pile yarns 22 facing each other with the cut 23 in between to be bent, expanding the cut 23, whereby the cushioning member 20 is pulled off from the endless band 51, and is separated from the endless band 51. Then, the manufactured cushioning member 20 is wound around the collecting drum 64, for being collected.

The following gives a description of advantages exhibited by the above embodiment.

The cushioning member 20 of the present embodiment includes a pair of base members 21, and pile yarns 22 bridging between the base members 21. Some of the pile yarns 22 are cut in intermediate portion between the base members 21, which forms the first and second cut pile yarns 22 facing each other with the cut 23 in between. By providing the cut 23, the pile yarns 22 appropriately perform the cushioning function and the resistance-reducing function in a well-balanced manner, in response to a relatively weak force applied thereto, for example, by swaying of the shutter 14 occurring when the shutter 14 is opened and closed, and preferentially perform the cushioning function in response to a relatively strong force applied thereto, for example, by urging of the wind. Further, when the shutter 14 is laterally swayed, the first and second cut pile yarns 22 are displaced laterally relative to each other with the cut 23 as a boundary in a manner coping with the motion of the shutter 14, whereby the state of the shutter 14 being in contact with the second base members 21 is maintained. This enables the cushioning members 20 to flexibly respond to motions of the shutter 14, and thereby perform the cushioning function of suppressing swaying of the shutter 14.

The pile yarns 22 are formed such that the cross-section perpendicular to the length of the base members 21 is generally rhombus-shaped. Therefore, responsive to a relatively weak external force applied to the cushioning members 20 by the shutter 14, some of the pile yarns 22 (non-cut pile yarns 22) are bent whereby both the cushioning function and the resistance-reducing function of causing the shutter 14 to be opened and closed smoothly can be performed in a well-balanced manner. Further, responsive to a relatively strong external force applied to the cushioning members 20 by the shutter 14, the whole pile yarns 22 (the cut pile yarns 22 and the non-cut pile yarns) are bent whereby the cushioning function is preferentially performed to suppress the motion of the shutter 14 and generation of unusual noise such as rattling noise caused by wind.

The cushioning member 20 is manufactured through the wrapping step of wrapping the pile yarns 22 around the surfaces of the endless band 51, the base member supply step of supplying the base members 21 from opposite lateral sides of the pile yarns 22, the bonding step of bonding the base members 21 to the pile yarns 22 by ultrasonic waves, and the cutting step of cutting some of the pile yarns 22 to form the cut 23. Further, in the separating step, the thus made cushioning member 20 is separated from the endless band 51 via the cut 23, and collected. This makes it possible to manufacture the cushioning members 20 almost automatically using the manufacturing apparatus without carrying out complicated operations. Therefore, it is possible to easily and reliably manufacture the cushioning member 20 comprised of a pair of base members 21 and pile yarns 22 bridging between the base members 21.

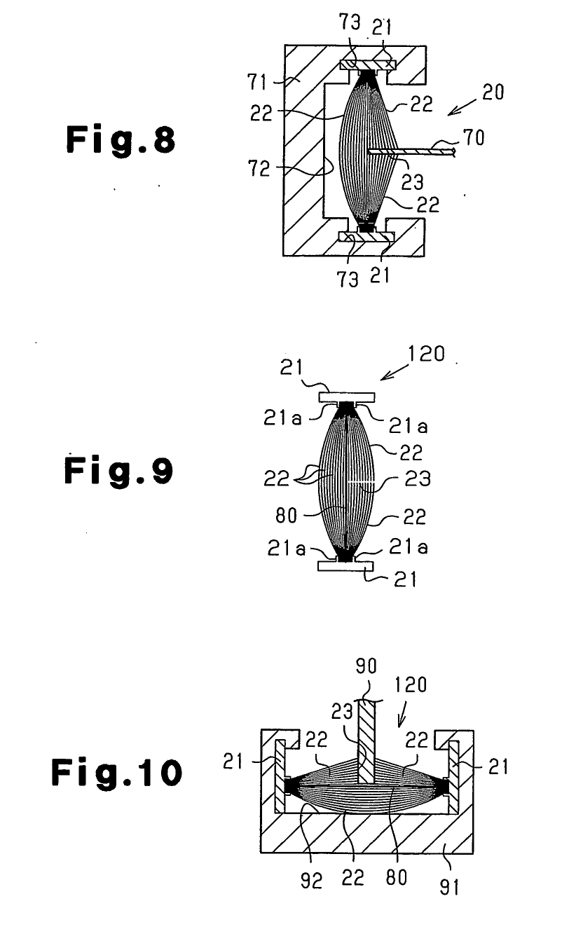

FIG. 8 illustrates an example in which the cushioning members 20 are used as supporting members for supporting the sides of a door or a window screen 70. The cushioning members 20 are attached to side frames 71 of a door or a window (only one of the side frames is shown in FIG. 8). Each side frame 71, which is a guiding member, has a guide groove 72 that extends vertically (in a direction perpendicular to the elevation of FIG. 8). A vertically extending receiving linear recess 17 is formed in each of inner sides of the guide groove 72 facing each other. The cushioning member 20 is fixed to the guide groove 72 of the side frame 71 by having a base members 21 inserted into the receiving linear recesses 73.

Each side of the screen 70, which is a moving member, is located in one of the guide grooves 72, and the screen can be moved up and down along the guide grooves 72. Each side section of the screen 70 is inserted into a cut 23 of one of the cushioning members 20. The first cut pile yarns 22 and the second cut pile yarns 22, which face each other with the cut 23 in between, hold the side section of the screen 70 and support the screen 70 from the front and rear sides. Therefore, the screen 70 is lifted and lowered with the side sections being held by the cushioning members 20, while sliding on the cut pile yarns 22. The cut pile yarns 22 satisfactorily exert a cushioning function to suppress shaking of the screen 70 frontward and rearward (in a vertical direction as viewed in FIG. 8). On the other hand, the non-cut pile yarns 22 of the cushioning member 20 receive a side edge of the screen 70, and exert a satisfactory cushioning function to suppress shaking of the screen 70 in the width direction (shaking to left and right as viewed in FIG. 8).

As described above, the cushioning member 20 is not only applicable to the shutter apparatus, but may also be used as supporting members for the screen 70. Other than the supporting members for the screen 70, the cushioning member 20 may be used as supporting members for various types of sheet members and plate members, such as glass panes and panels. In these case, the cushioning member 20 may be used for fixed sheet members or plate members or for slidable sheet members or plate members. Further, the cushioning member 20 may be attached to the edge of a mesh screen. In this case, the distal ends of the cut pipe yarns 22 of the cushioning member 20 are engaged with the mesh of the screen, thereby functioning to prevent entry of small animals such as insects.

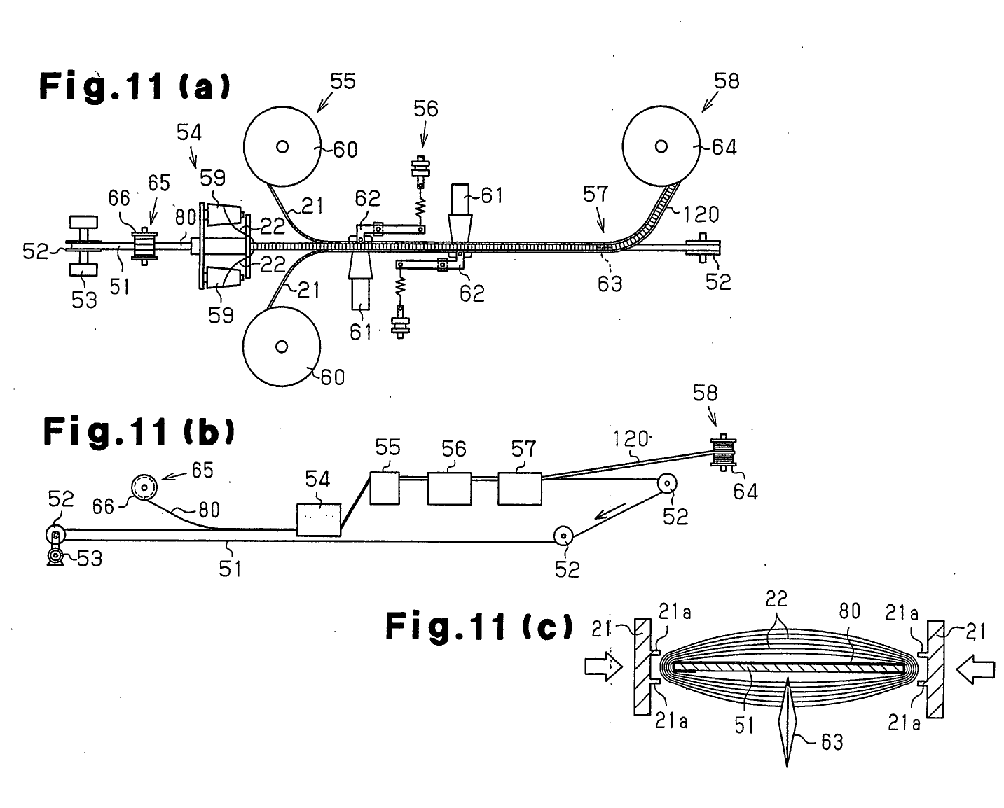

A third embodiment of the present invention will now be described with reference to FIGS. 9 and 11(c). The differences from the first embodiment of FIGS. 1 to 8 will mainly be, discussed.

As shown in FIG. 9, a cushioning member 120 in this embodiment is different from the cushioning member 20 of FIG. 1 in that a film 80 extends between the base members 21. The film 80 is located at the center in the width direction of the base members 21, and extends along the entire length of the cushioning member 120 in the longitudinal direction of the base members 21. The cut pile yarns 22 are provided on one side of the film 80, and the non-cut pile yarns 22 are located provided on the other side of the film 80.

The film 80 is formed of a material having a high durability and excellent in a restoring property and a non-water-absorbing property. Preferably, the film 80 is formed of a polypropylene sheet. The thickness of the film 80 is selected in accordance with the use of the cushioning member 120. In a case where a high flexibility of the cushioning member 120 is chiefly required, a relatively thin film is used as the film 80. In a case where a high load-carrying capacity is required, a relatively thick film is used as the film 80.

In a case where the cushioning member 120 having the film 80 is applied to the shutter apparatus shown in FIG. 4 instead of the cushioning member 20 of FIG. 1 having no film 80, the following advantages are obtained. That is, compared to the cushioning member 20 having no film 80, the cushioning member 120 having the film 80 has a greater resilient force (elastic force), and has a better shielding effect against liquid and foreign matter. Therefore, in a situation where the cushioning member receives relatively great load from the shutter 14 of the shutter apparatus, the cushioning member 120 having the film 80 is preferably applied to the shutter apparatus. Further, if the cushioning member 120 having the film 80 is applied to the shutter apparatus, wind, rain, and dust are reliably prevented from entering the interior of the support frame 12. Since the film 80 is located at the center in the width direction of the cushioning member 120, the cushioning member 120 is deformed by received load in a well-balanced manner, and thus performs the cushioning function and the resistance-reducing function in a satisfactory manner.

FIG. 10 illustrates an example in which the cushioning member 120 of FIG. 9 is used as a support member for a glass pane 90 of a sliding window. The cushioning member 120 is attached to a lower frame 91 of the sliding window such that the cut 23 faces upward. The lower frame 91, which is a guiding member, has a guide groove 92 that extends horizontally (in a direction perpendicular to the elevation of FIG. 10). The base members 21 of the cushioning member 120 are fixed to inner sides of the guide groove 92 facing each other. The coupling positions of the pile yarns 22 to the base members 21 are displaced from the center of the width of the base members 21, such that the non-cut pile yarns 22 contact the bottom of the guide groove 92.

The lower side of the glass pane 90, which is a moving member, is located in the guide groove 92, and the glass pane 92 can be moved horizontally along the guide groove 92. The lower side of the glass pane 90 is inserted into the cut 23 of the cushioning member 120. The first cut pile yarns 22 and the second cut pile yarns 22, which face each other with the cut 23 in between, hold the lower end section of the glass pane 90 and support the glass pane 90 from the front and rear sides. Therefore, the glass pane 90 is moved with the lower end section being held by the cushioning member 120, while sliding on the cut pile yarns 22. The cut pile yarns 22 satisfactorily exerts a cushioning function to prevent the glass pane 90 from shaking frontward and rearward (to left and right as viewed in FIG. 10).

On the other hand, the film 80 receives the lower edge of the glass pane 90. To bear the load applied by the glass pane 90, a relatively thick material is preferably used as the film 80. Specifically, a polypropylene sheet having a thickness that is greater than the size of the pile yarns 22 is preferably used as the film 80. Part of the non-cut pile yarns 22 between the bottom of the guide groove 92 and the film 80 functions, together with the film 80, as a cushion to receive the vertical load. Accordingly, the glass pane 90 is satisfactorily prevented from shaking vertically, and vertical impacts are satisfactorily absorbed.

Like the cushioning member 20 of FIG. 1 having no film 80, the cushioning member 120 of FIG. 9 having the film 80 may be used as a supporting member for various types of sheet members and plate members other than the supporting member for the glass pane 90. For example, the cushioning member 120 having the film 80 may be applied to the screen 70 shown in FIG. 8, doors, and panels. In these case, the cushioning member 20 may be used for fixed sheet members or plate members or for slidable sheet members or plate members.

FIGS. 11(a) to 11(c) illustrate an apparatus for manufacturing the cushioning member 120 shown in FIG. 9. The manufacturing apparatus shown in FIGS. 11(a) and 11(b) is formed by adding a film supply section 65 to the manufacturing apparatus shown in FIGS. 7(a) and 7(b). The film supply section 65 is located upstream of the pile yarn supply section 54. The film supply section 65 has a spool 66 for accommodating the film 80 in a wounded state. The film 80 drawn from the spool 66 is supplied to the outer circumferential surface of the endless band 51, and then, together with the endless band 51, supplied to the pile yarn supply section 54.

The cushioning member 120 is made through, after the film supply step, the wrapping step, the base member supply step, the bonding step, the cutting step, and the separating step. The film supply step performed for supplying the film 80 to the outer circumferential surface of the endless band 51, and is executed by the film supply section 65. The film 80 drawn from the spool 66 is supplied to the outer circumferential surface of the endless band 51, and covers the outer surface of the endless band 51 (see FIG. 11(c)).

In the next wrapping step, pile yarns 22 supplied by the pair of the bobbins 59 are wrapped around the endless belt 51 covered with the film 80 (see FIG. 11(c)). Thereafter, in the same manner as the procedure shown in FIGS. 7(a) and 7(b), the base member supply step, the bonding step, the cutting step, and the separating step are performed. Particularly, in the bonding step, the base members 21, the pile yarns 22, and the film 80 are joined together at contacting areas by vibrations of ultrasonic waves generated by the horns 61.

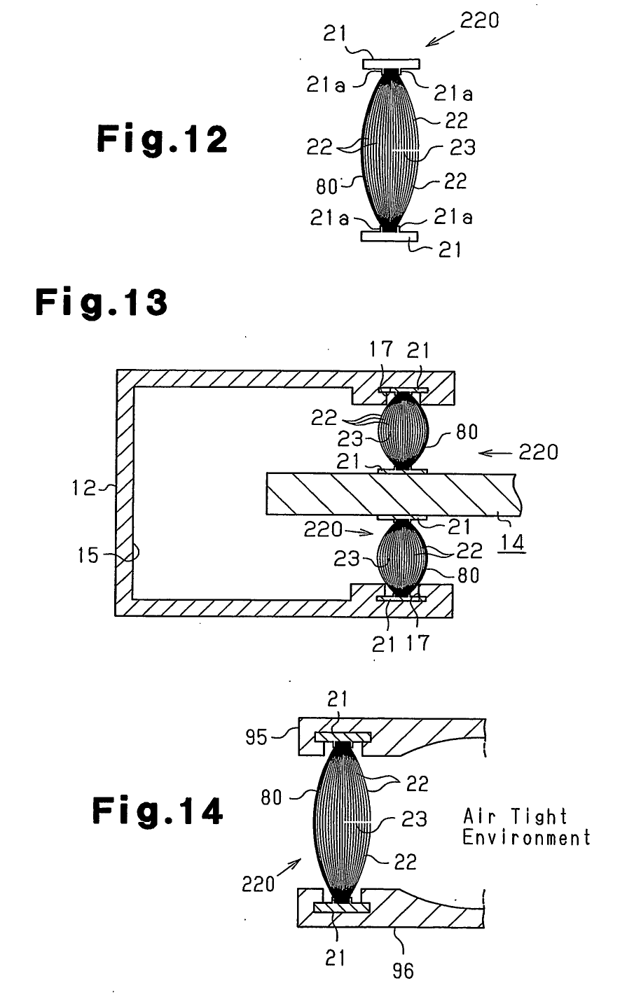

A third embodiment of the present invention will now be described with reference to FIGS. 12 to 15(c). The differences from the second embodiment of FIGS. 9 to 11(c) will mainly be discussed.

As shown in FIG. 12, a cushioning member 220 in this embodiment has a film 80 extending between the base members 21 like the cushioning member 120 of FIG. 9. However, this cushioning member 220 of this embodiment is different from the cushioning member 120 of FIG. 9 in that the film 80 is located outward of the pile yarns 22. The film 80 covers the non-cut pile yarns 22 at a side opposite from the cut 23.

FIG. 13 illustrates an example in which the cushioning. members 220 of FIG. 12 are used in a shutter apparatus. The cushioning members 220 are attached to the support frame 12 such that the cuts 23 face the interior of the support frame 12, or the films 80 faces outward of the support frame 12. Since the films 80 face outward, this configuration has a better shielding effect compared to a case where the cushioning member 120 of FIG. 9 is applied to a shutter apparatus. Further, since the pile yarns 22 are shield from the exterior of the support frame 12 with the film 80, the pile yarns 22 are prevented from being contaminated.

FIG. 14 illustrates an example in which the cushioning member 220 of FIG. 12 is used in a ventilation system. The ventilation system includes a blower apparatus 95 and a duct 96 extending form the blower apparatus 95. The cushioning member 220 is located between the blower apparatus 95 and the duct 96. The cushioning member 220 hermetically connects the blower apparatus 95 with the duct 96. One of the base members 21 is attached to the blower apparatus 95, and the other base member 21 is attached to the duct 96. The film 80 is arranged to face the exterior.

The blower apparatus 95 has a motor (not shown) and generates an air flow in the duct 96 by activating the motor. The cushioning member 220 having the film 80 prevents air from leaking from the joint between the blower apparatus 95 and the duct 96 and forms an airtight space between the blower apparatus 95 and the duct 96. Further, the cushioning member 220 permits the blower apparatus 95 and the duct 96 to move relative to each other, thereby preventing vibrations generated by the motor from being transmitted from the blower apparatus 95 to the duct 96. That is, the cushioning member 220 satisfactorily functions as an airtight seal and a vibration damper.

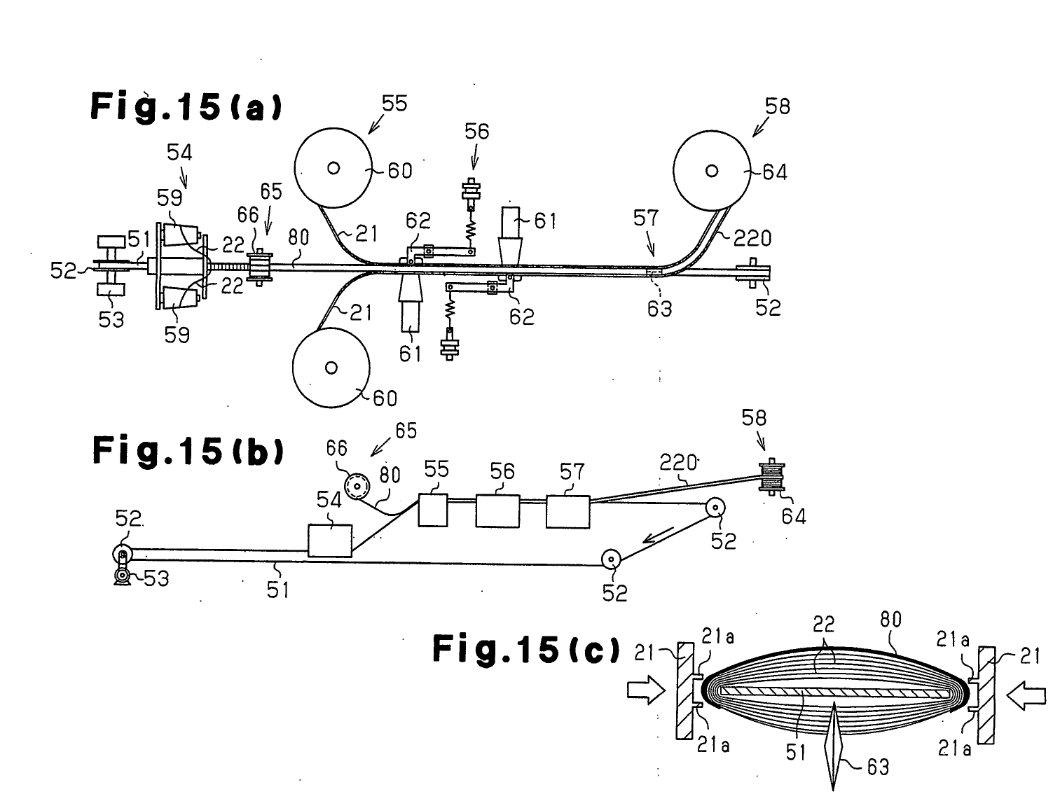

FIGS. 15(a) to 15(c) illustrate an apparatus for manufacturing the cushioning member 220 shown in FIG. 12. The manufacturing apparatus of FIGS. 15(a) and 15(b) is different from the manufacturing apparatus of FIGS. 11(a) and 11(b) in that the film supply section 65 is located between the pile yarn supply section 54 and the base member supply section 55.

The cushioning member 220 is made by performing the film supply step after the wrapping step, and then performing the base member supply step, the bonding step, the cutting step, and the separating step. In the film supply step, the film 80 is supplied to the pile yarns 22, which has been wound around the endless band 51 in the wrapping step, from the outer circumference of the endless band 51. The film 80 drawn from the spool 66 of the film supply section 65 covers the pile yarns 22 on the outer circumferential surface of the endless band 51 (see FIG. 15(c)).

In the base member supply step, the base members 21 unwound from the respective supply drums 60 are supplied such that the base members 21 are positioned at the opposite lateral sides of the endless band 51. At this time, positioning is carried out such that each side section of the endless band 51 is located between the guide linear projections 21a of one of the base members 21, and both ends of the film 80 are folded to encompass the pile yarns 22 on the endless band 51 (see FIG. 15(c)). Thereafter, in the same manner as the procedure shown in FIGS. 11(a) and 11(b), the bonding step, the cutting step, and the separating step are performed.

It should be noted that the present embodiments can be modified to provide following variations thereof.

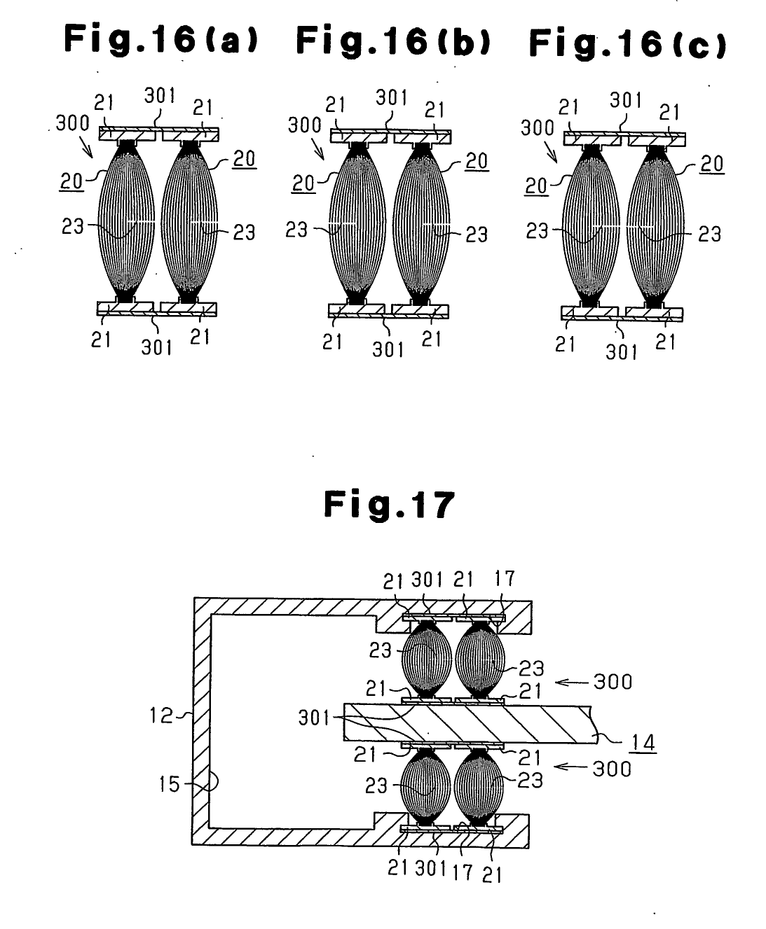

As shown in FIGS. 16(a) to 16(c), a joint cushioning member 300 may be formed by connecting a pair of the cushioning members 20 of FIG. 1. The joint cushioning member 300 is formed by placing the two cushioning members 20 side by side and coupling each adjacent pair of the base members 21. The adjacent base members 21 are coupled to each other with an adhering member 301, which is, for example, an adhesive tape or a Typar (a registered trademark of Du Pont).

In FIG. 16(a), the cushioning members 20 are coupled such that the cuts 23 face the same direction. In FIG. 16(b), the cushioning members 20 are coupled such that the cuts 23 face away from each other (face outward). In FIG. 16(b), the cushioning members 20 are coupled such that the cuts 23 face each other (face inward).

FIG. 17 illustrates an example in which the joint cushioning members 300 of FIG. 16(a) are used in a shutter apparatus. Since the joint cushioning members 300 contact the shutter 14 at a large area, the shutter 14 is more satisfactorily prevented from shaking and vibrating than a case where the cushioning members 20 of FIG. 1 is used. It is needless to mention that the joint cushioning member 300 of FIGS. 16(b) and 16(c) may be applied to a shutter apparatus. Any of the joint cushioning members 300 shown in FIGS. 16(a) to 16(c) is selected according to the type of shutter apparatuses and the environments in which the shutter apparatuses are installed.

Although not illustrated, each of the joint cushioning members 300 shown in FIGS. 16(a) to 16(c) may be formed by coupling a pair of the cushioning members 120 shown in FIG. 9 or by coupling a pair of the cushioning members 220 shown in FIG. 12. In this case, the joint cushioning member 300 may be applied to an apparatus that requires airtightness, such as the ventilation system shown in FIG. 14.

Further, each of the joint cushioning members 300 shown in FIGS. 16(a) to 16(c) may be formed by coupling any two of the cushioning member of FIG. 1, the cushioning member 120 of FIG. 9, and the cushioning member 220 of FIG. 12.

At least one of the base members 21 and the pile yarns 22 may be given with weather resistance. The weather resistance can be given by a method of blending a weather resistance agent in a synthetic resin used for the base members 21 or the pile yarns 22, a method of coating the base members 21 or the pile yarns 22 with a processing liquid containing the weather resistance agent, and so forth. As the weather resistance agent, there may be mentioned a hindered amine-based light stabilizer, a benzotriazole-based ultraviolet absorber, etc. This configuration can enhance the durability of the base members or the pile yarns. In the cushioning members 120, 220 each having the film 80, the film 80 may also given with weather resistance in the same manner.

The base members 21 are not limited to a film, but they may be formed by a woven fabric, a knitted fabric, a nonwoven fabric, a sheet, or the like, made of a synthetic resin.

The shutter apparatus is not limited to a type that is vertically opened and closed, but other types that are opened and closed horizontally, including a type that is opened and closed in a front-rear direction and a type that is opened and closed in a left-right direction, or a type that is once opened/closed in a front-rear direction and then vertically opened/closed, can be made.

The back surface of the first base members 21 fixed to each support frame 12 in the shutter apparatus may be formed with an adhesive layer, for example, by applying a pressure-sensitive adhesive agent, such as a rubber-based agent or a acrylic-based agent, or a double-faced adhesive tape formed by coating a pressure-sensitive adhesive agent on both sides of a core material. Then, the cushioning member 20 may be attached to the inner bottom surface of the receiving liner recess 17 via the adhesive layer. Alternatively, the support frame 12 may be formed by omitting the receiving linear recesses 17 or the guide groove 15, and the cushioning member 20 may be attached to a predetermined location of the support frame 12 via the adhesive layer. When the cushioning members are applied to apparatus other than shutter apparatuses, it is needless to mention that the base members 21 may be attached to an object via adhesive layer.

In the manufacturing method according to the illustrated embodiments, the cushioning member 20 (120, 220) is separated from the endless band 51 and then wound around the collecting drum 64, for being collected. This is not limitative. That is, after the cushioning member 20 (120, 220) is pulled off and separated from the endless band 51 by manual operation of workers, the cushioning member 20 (120, 220) as separated may be cut to a desired length without being wound up, for being collected as cushioning members 20 (120, 220) having a linear shape. When configured as described above, the collecting drum 64 may be omitted, and the construction of the manufacturing apparatus can be simplified.

1. A cushioning member comprising:
a pair of base members disposed in a manner opposed to each other and having a band shape; and
a plurality of pile yarns bridging between the base members, the cushioning member being characterized in that:
some of the pile yarns are cut at an intermediate portion between the base members to form first cut pile yarns and second cut pile yarns, the first and second cut pile yarns facing each other with a cut in between.

2. The cushioning member according to claim 1, wherein the pile yarns bulge in both lateral directions of the base members, and wherein the degree of the bulging increases toward the intermediate portion between the base members.

3. The cushioning member according the claim 1, wherein the pile yarns that are located toward one side from the center in the direction of width of the base members are cut at the intermediate portion between the base members.

4. The cushioning member according to claim 1, wherein the number of the pile yarns set per inch along the length of the base members is 1000 to 10000.

5. The cushioning member according to claim 1, wherein weather resistance is given to the base members or the pile yarns.

6. The cushioning member according to claim 1, wherein each of the pile yarns has a single yarn fineness of 5 to 110 decitex.

7. The cushioning member according to claim 1, wherein the pile yarns are formed by multi-filament yarns or mono-filament yarns, and wherein each of the pile yarns has a fineness of 100 to 2200 decitex.

8. The cushioning member according to claim 1, further comprising a film, wherein the film bridges between the base members to extend along a longitudinal direction of the base members.

9. The cushioning member according to claim 8, wherein the film is substantially located at the center in the width direction of the base members.

10. The cushioning member according to claim 9, wherein the first and second cut pile yarns are located at one side of the film, and non-cut pile yarns are located at the other side of the film.

11. The cushioning member according to claim 8, wherein the film is located outward of the pile yarns.

12. The cushioning member according to claim 11, wherein, at a side opposite from the cut, the film covers the non-cut pile yarns.

13. The cushioning member according to claim 8, wherein the film is made a polypropylene sheet.

14. The cushioning member according to claim 8, wherein the cushioning member is located between two airtight space forming members that are connected to each other to form an airtight space, wherein one of the base members is attached to one of the airtight space forming members, and the other base member is attached to the other airtight space forming member.

15. The cushioning member according to claim 1, wherein the cushioning member is located between a guiding member and a moving member movable along the guiding member, wherein one of the base members is attached to the guiding member, and the other base member is in contact with the moving member.

16. The cushioning member according to claim 1, wherein the cushioning member is located between a guiding member and a sheet-like or plate-like moving member movable along the guiding member, and wherein the base members are attached to the guiding member, and the cut receives an edge portion of the moving member.

17. The cushioning member according to claim 1, wherein the cushioning member is attached to an edge portion of sheet-like or plate-like member, and wherein the cut receives the edge portion of the sheet-like or plate-like member.

18. A cushioning member for a shutter apparatus, the shutter apparatus including a pair of support frames opposed to each other, and a shutter supported by the support frames to move along the support frames, wherein the shutter is capable of being wound at one end, and each side of the shutter is supported by the corresponding one of the support frames, wherein the cushioning member being disposed between each of the support frames and the corresponding side of the shutter, the cushioning member comprising:
a pair of base members disposed in a manner opposed to each other and having a band shape; and
a plurality of pile yarns bridging between the base members, the cushioning member being characterized in that:
one of the base members is attached to each of the support frames, and the other base member is in contact with the shutter; and
some of the pile yarns are cut at an intermediate portion between the base members to form first cut pile yarns and second cut pile yarns, the first and second cut pile yarns facing each other with a cut in between.

19. A method of manufacturing a cushioning member, characterized by:
a wrapping step of wrapping pile yarns around surfaces of an endless band while rotating the endless band;
a base member supply step of supplying to the pile yarns wound around the endless band of pair of base members which are band-shaped from opposite lateral sides of the endless band;
a bonding step of bringing the supplied base members into contact with the pile yarns, and bonding the base members to the pile yarns by using ultrasonic waves;
a cutting step of cutting the pile yarns located on one of inner and outer circumferences of the endless band at intermediate portion between the base members, thereby forming a cut in the pile yarns; and
a separating step of separating the pile yarns together with the base members from the endless band via the cut.

20. The manufacturing method according to claim 19, further comprising a film supply step performed prior to the wrapping step, wherein, in the film supply step, a film is supplied to a circumferential surface of the endless band that is opposite from the side on which the pile yarns to be cut in the cutting step are provided, such that the film covers the circumferential surface, and wherein, in the bonding step, the pile yarns and the film are bonded to the base members.

21. The manufacturing method according to claim 19, further comprising a film supply step performed between the wrapping step and the base member supply step, wherein, in the film supply step, a film is supplied to a circumferential surface of the endless band that is opposite from the side on which the pile yarns to be cut in the cutting step are provided, such that the film covers the pile yarns on the circumferential surface, and wherein, in the bonding step, the pile yarns and the film are bonded to the base members.
